(19) United States
(12) Patent Application Publication
(10) Pub. No.: US 2004/0151402 A1
(43) Pub. Date: Aug. 5, 2004

(54) Image processing program products allowing a read original to be used in a computer

(75) Inventor: Tetsuya Sugimoto, Muko-Shi (JP)

Correspondence Address: MORRISON & FOERSTER LLP, 1650 TYSONS BOULEVARD, SUITE 300, MCLEAN, VA, 22102, US

(73) Assignee: Minolta Company, Ltd., Osaka-Shi (JP)

(21) Appl. No.: 10/422,787

(22) Filed: Apr. 25, 2003

(30) Foreign Application Priority Data
Jan. 31, 2003 (JP) 2003-024258

(51) Int. Cl. G06K 9/54

(52) U.S. Cl. 382/305

(57) ABSTRACT

Scanner software obtains image data from a scanner device and stores the data to a file storage, and in response to an instruction received from a user reads via the scanner device or accesses to the file storage portion to obtain image data and transfers the data to an application. This can eliminate the necessity of again reading image data once read via the scanner device and the image data, stored in the file storage portion, can be taken in to the application.

This application is based on Japanese Patent Application No. 2003-24258 filed with Japan Patent Office on Jan. 31, 2003, the entire content of which is hereby incorporated by reference.

### BACKGROUND OF THE INVENTION

1. Field of the Invention

The present invention relates generally to image processing program products, image processing methods, image reading apparatuses and image processing systems, and particularly to those allowing image data read via a scanner device to be usable in applications.

2. Description of the Related Art

In a computer when an application processing an image is being effected, image data that is used in the application may be obtained from a scanner device or any other similar image reader having a scanning function reading an original. In doing so, to cause the scanner device to perform a scanning operation the computer executes a program referred to as scanner software.

Conventional scanner software allows a scanner device to read an original and subjects the image data to image-processing or any other similar processing, and thereafter renders it usable in an application.

Japanese Laid-Open Patent Publication No. 2002-99496 discloses an information processor selecting and initiating an application suitable for data received from scanner equipment.

With conventional scanner software as disclosed in the publication, however, if image data previously read via a scanner device is to again be used in an application the original must again be read by the scanner device, which again requires the original.

### SUMMARY OF THE INVENTION

The present invention therefore contemplates an image processing program product, image processing method, image reading apparatus and apparatus and image processing system allowing image data of an original once read via a scanner device to be used in an application without the necessity of again reading the original via the scanner device.

The above objects of the present invention is achieved by an image processing program product causing a computer to perform an image processing including the steps of: receiving an input of image data from an image reader; storing an image data based on the input image data to a memory device; obtaining image data from one of the image reader and the memory device in response to an instruction from a user; and transferring the obtained image data to render the obtained image data usable in an application.

Further the product desirably causes the computer to perform the step of processing the obtained image data in response to an instruction from the user, using information unique to the image reader, wherein the step of transferring renders the processed image usable in the application.

Still further the step of storing desirably attaches information regarding a date of acquisition of the image data to the image data for storage to the memory device.

Alternatively the step of storing desirably attaches information regarding an operator to the image data for storage to the memory device.

Alternatively the step of storing desirably provides the image data with a file name received from the user for storage to the memory device.

Alternatively the step of storing desirably provides the image data with an automatically generated file name for storage to the memory device.

Alternatively the step of storing desirably provides the image data with a particular file name for storage to the memory device.

Alternatively the step of storing desirably stores the image data to the memory device at a predetermined location corresponding to an attribute of the image data.

Alternatively the step of storing desirably stores the image data to the memory device at a predetermined location associated with an operator.

Further the step of processing is desirably a color matching process unique to the image reader.

Alternatively the step of processing is desirably an exposure correction process correcting uneven exposure.

Alternatively the step of processing is desirably a noise removal process removing noise from the obtained image.

Further the product desirably causes the computer to perform the step of receiving an instruction indicating whether the obtained image data should be processed, wherein the step of processing processes the obtained image data in accordance with the instruction received.

Still further the step of storing desirably stores either the processed image data, or the input of the image data, to the memory device.

Still further the step of receiving desirably receives an instruction indicating specific detail of the processing.

To achieve the above objects the present invention in another aspect provides an image processing method including the steps of: receiving an input of image data from an image reader; storing an image data based on the input image data to a memory device; obtaining image data from one of the image reader and the memory device in response to an instruction from a user; and transferring the obtained image data to render the obtained image data usable in an application.

Further the method desirably includes the step of processing the obtained image data in response to an instruction from the user, using information unique to the image reader, wherein the step of transferring renders the processed image usable in the application.

Still further the step of processing is desirably an exposure correction process correcting uneven exposure.

Further the method desirably includes the step of receiving an instruction indicating whether the obtained image data should be processed, wherein the step of processing processes the obtained image data in accordance with the instruction received.

To achieve the above objects the present invention in still another aspect provides an image processing apparatus including: a read portion reading an original to obtain image data; a storage portion storing the image data to a memory device; an acquisition portion operative in response to an instruction received from a user to obtain image data from one of the read portion and the memory device; and a transfer portion transferring the obtained image data to a different device.

Further the apparatus desirably includes a processing portion operative in response to an instruction received from the user to process the obtained image data, using information unique to the image reader, wherein the transfer portion renders the processed image usable in the application.

Still furthermore the apparatus desirably includes a receiving portion receiving an instruction indicating whether the obtained image data should be processed, wherein the processing portion processes the obtained image data in accordance with the instruction received.

Still furthermore the receiving portion desirably receives an instruction indicating specific detail of the processing.

To achieve the above objects the present invention in still another aspect provides an image processing system including: a read portion using an image reader to read an original; a storage portion storing read image data to a memory device; an acquisition portion operative in response to an instruction received from a user to obtain image data from one of the image reader and the memory device; and a transfer portion rendering the obtained image data usable in an application of an image processing apparatus.

Further the system desirably includes a processing portion operative in response to an instruction received from the user to process the obtained image data, using information unique to the image reader, wherein the transfer portion renders the processed image usable in the application.

Still furthermore the system desirably includes a receiving portion receiving an instruction indicating whether the obtained image data should be processed, wherein the processing portion operates in response to the received instruction to subject the obtained image data to the processing.

Further the processing performed by the processing portion is desirably a color matching process unique to the image reader.

Alternatively the processing performed by the processing portion is desirably an exposure correction process correcting uneven exposure.

Alternatively the processing performed by the processing portion is desirably a noise removal process removing noise from the obtained image.

Still furthermore the receiving portion desirably receives an instruction indicating specific detail of the processing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a specific example of a configuration of an image processing system of the present invention in an embodiment.

FIG. 2 is a block diagram showing a specific example of a hardware configuration of a client personal computer (PC) 1.

FIG. 3 is a block diagram showing a functional configuration of client PC 1.

FIG. 4 is a flow chart of an image data storage process.

FIG. 5 is a flow chart of an image data transfer process.

FIG. 6 is a block diagram showing a functional configuration of client PC 1 and a scanner device 2 in an exemplary variation.

### DESCRIPTION OF THE PREFERRED EMBODIMENTS

Hereinafter with reference to the drawings the present invention in an embodiment will be described. In the following description, like components are denoted by like reference characters. The components thus denoted are also identical in name and function.

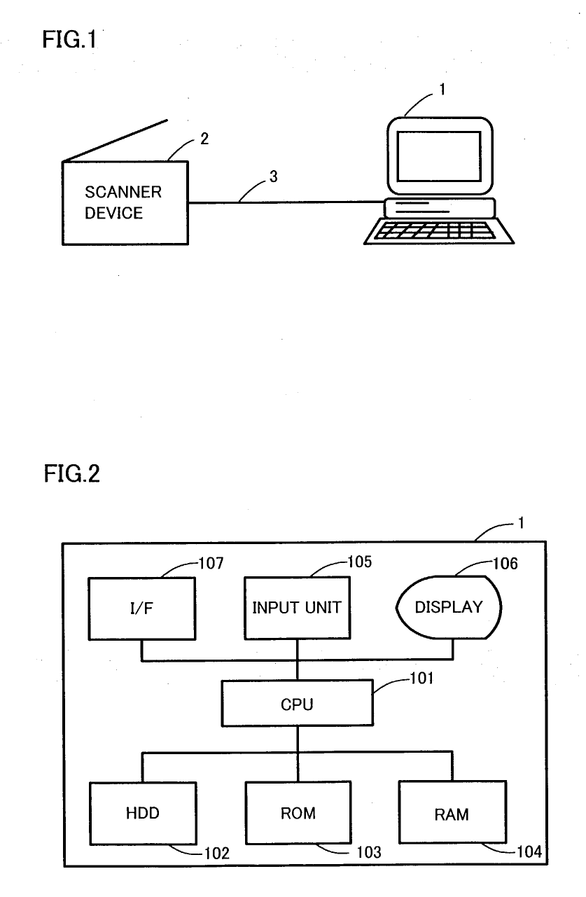

FIG. 1 shows an image processing system including a scanner device 2 reading an original image, and a client personal computer (hereinafter referred to as “client PC”) 1 processing image data read via scanner device 2. They are connected by a network 3.

Scanner device 2 has a scanner function reading image data and an output function outputting image data obtained through the scanner function and may be a copier, a facsimile transmitter, a so-called multi function peripheral (MFP) or any other similar multi functional device. The function to read image data may be provided by other devices such as a digital camera, a digital video camera or the like.

Network 3 may be a network allowing communication through a local area network (LAN) or any other similar dedicated line, a network allowing communication through the Internet or any other similar public telephone line, or a network allowing wireless communication.

Client PC 1 is configured for example of a typical personal computer. FIG. 2 is a block diagram of a specific example of a hardware configuration of client PC 1.

With reference to FIG. 2, client PC 1, controlled by a central processing unit (CPU) 101, processes image data received from scanner device 2 through an interface (I/F) 107.

CPU 101 executes a program, which is stored in a storage portion corresponding to a hard disk drive (HDD) 102 or a read only memory (ROM) 103. A random access memory (RAM) 104 acts as a temporal working memory when CPU 101 executes the program. The user inputs information, instructions and the like via an input unit 105 configured for example of a keyboard, a mouse and the like. Image data received via scanner 2, a result of processing the data, and the like are displayed on a display 106. Note that the FIG. 2 configuration is that of a typical personal computer and the configuration of client PC 1 is not limited to the configuration shown in FIG. 2.

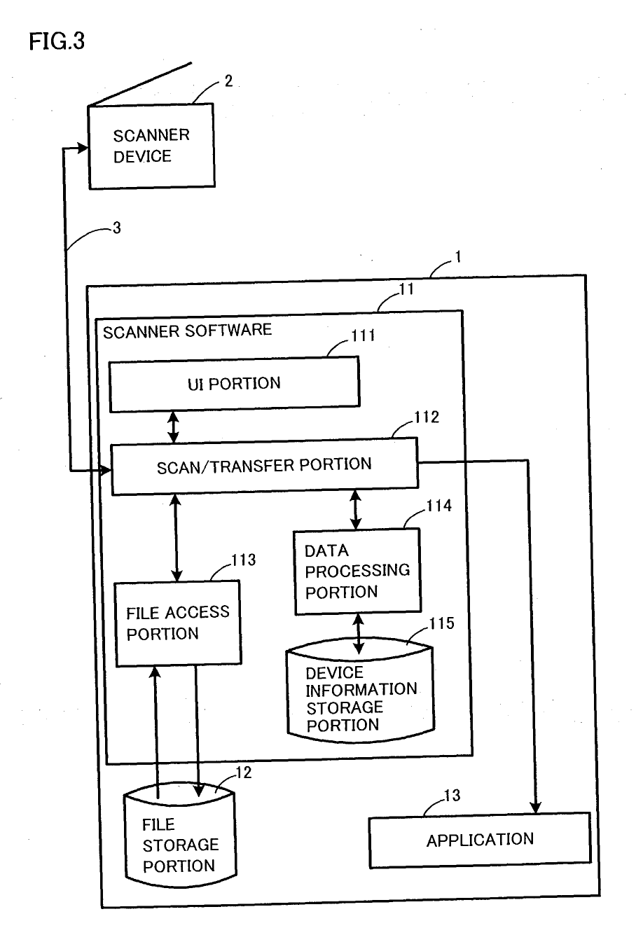

FIG. 3 is a block diagram showing a functional configuration of client PC 1. With reference to the figure, client PC 1 stores in HDD 102 or ROM 103 scanner software 11 and application software (hereinafter simply referred to as “application”) 13 corresponding to programs. It also includes in HDD 102 or RAM 104 a file storage portion 12 corresponding to a location for storing a file including image data.

Scanner software 11 is a program for communicating image data, a control signal and the like with scanner device 2. It is a program corresponding to scanner device 2 and automatically initiated and executed when client PC 1 causes scanner device 2 to read an original image.

Application 13 is a program executing an application for processing image data and corresponds for example to photoretouching software.

File storage portion 12 stores a file including image data obtained via scanner device 2.

In client PC 1, CPU 101 reads scanner software 11 from HDD 102 or ROM 103 and executes the software to present each function shown in FIG. 3. More specifically, with reference to FIG. 3, scanner software 11 includes a user interface (UI) portion 111 receiving a user input, a scan/transfer portion 112 causing scanner device 2 to scan an original and also transferring image data to application 13 so that the image data can be used in application 13, a file access portion 113 accessing file storage portion 12 in response to an instruction received from scan/transfer portion 112, a data processing portion 114 processing image data passed from scan/transfer portion 112, and a device information storage portion 115 storing information associated with scanner device 2.

When scanner software 11 is initiated, UI portion 111 controls UI displayed on display 106 to receive an input such as an instruction input by a user, and UI portion 111 operates in response to an instruction received from the user to send a control signal to scan/transfer portion 112. [0058] Scan/transfer portion 112 having received the control signal from UI portion 111 effects a processing corresponding to the control signal. More specifically, if the control signal received from UI portion 111 is a signal for control causing scanner device 2 to read an original image, scan/transfer portion 112 sends a control signal to scanner device 2 through networks 3 to read a set original.

Scanner device 2 having received the control signal from scan/transfer portion 112 reads the set original and passes image data to scan/transfer portion 112 through network 3.

If the control signal received from UI portion 111 is a signal for controlling reading a particular file stored in file storage portion 12, scan/transfer portion 112 sends a control signal to file access portion 113 to access file storage portion 12 to read the file therefrom.

File access portion 113 having received the control signal from scan/transfer portion 112 responds to the control signal by accessing file storage portion 12 to read the file, and passes to scan/transfer portion 112 image data included in the read file.

If the control signal received from UI portion 111 is a signal for controlling predetermined image data to be transferred to application 13 so that the data can be used in application 13, scan/transfer portion 112 transfers to application 13 image data received from scanner device 2 or image data received from file access portion 113.

Note that the term “transfer” used herein is not limited to simply transmitting and receiving data. It also means rendering image received from scanner device 2 or that from file access portion 113 usable in application 13. For example, if image data received from scanner device 2 or that from file access portion 113 is RGB gray-scale data or any other similar data format that cannot be used in application 13, “transfer” means converting the data format of the image data of interest to a data format which can be used in application 13. Furthermore, if image data received from scanner device 2 or that from file access portion 113 is stored at a memory location that cannot be read in application 13, “transfer” means moving (or copying) the image data to a location readable in application 13.

Furthermore, if the control signal received from UI portion 111 is a signal for control to process particular image data, as predetermined, and transfer the processed data to application 13 so that the data can be used in application 13, scan/transfer portion 112 sends image data received from scanner device 2 or that from file access portion 113 to data processing portion 114 as well as a control signal to process the image data, as predetermined.

Data processing portion 114 having received the image data and the control signal from scan/transfer portion 112 processes the image data, as predetermined. More specifically, data processing portion 114 subjects the image data to a color matching process, an exposure correction process correcting uneven exposure, a noise removal process removing noise from image data, a gradient correction process, and the like. In doing so, data processing portion 114, if required, reads from device information storage portion 115 information corresponding to scanner device 2, such as a profile unique to scanner device 2 and used for example to subject an image read via scanner device 2 to color-matching, exposure correction and noise removal, and processes the image data in accordance with the read information. Furthermore, if image data has attached thereto information indicating a resolution, a size, a color type or any similar parameter set for scanner device 2, data processing portion 114 may refer to the information indicative of the parameters, as required, to process the image data. Data processing portion 114 passes the processed image data to scan/transfer portion 112.

Scan/transfer portion 112 having received the processed image data from data processing portion 114 transfers the received image data to application 13.

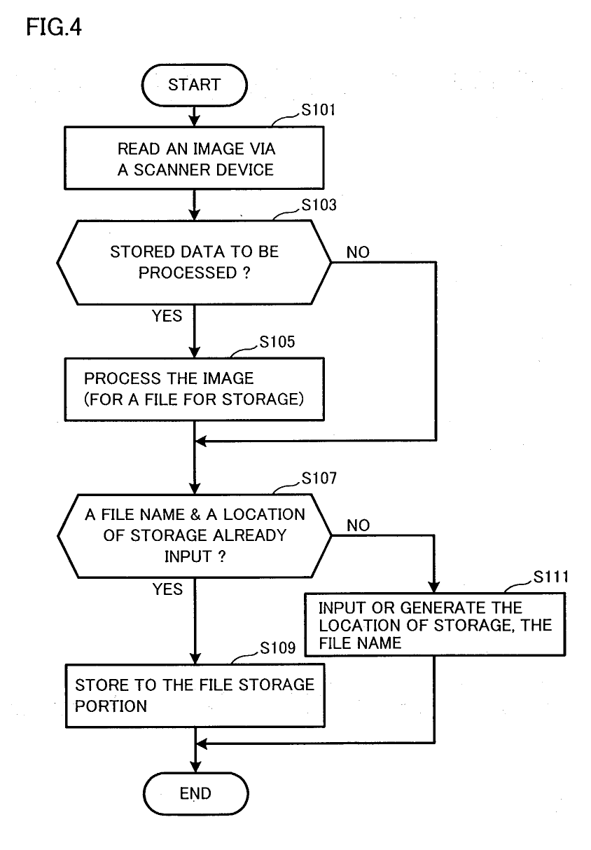

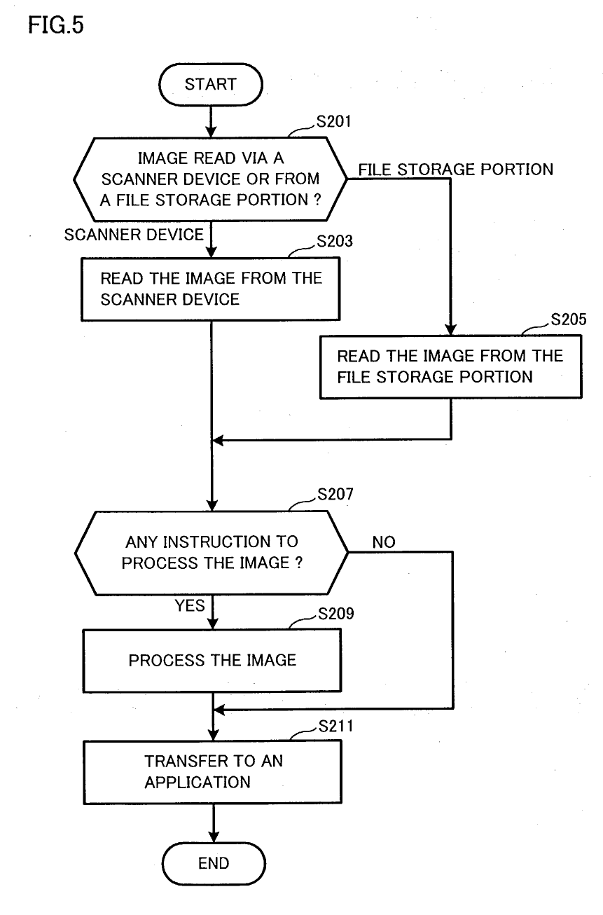

When client PC 1 executes scanner software 11 a process is effected, as described hereinafter with reference to the flow charts shown in FIGS. 4 and 5. The FIGS. 4 and 5 flow charts represent processes implemented by CPU 101 reading scanner software 11 from HDD 102 or ROM 103, developing the software on RAM 104 and executing it.

The FIG. 4 flow chart represents an image data storage process storing image data read via scanner device 2. The FIG. 4 process is initiated by CPU 101 automatically reading and executing scanner software 11 when a user causes scanner device 2 to read an original. Alternatively, the FIG. 4 process may be initiated by CPU 101 automatically reading and executing scanner software 11 when a user starts application 13 and provides an instruction to obtain image data via scanner device 2. Alternatively, the FIG. 4 process may be initiated by designating storage of image data before a user causes scanner device 2 to read an original. Alternatively, the FIG. 4 process may be initiated in accordance with a setting of whether image data should be stored or not that UI portion 111 receives from a user before the user causes scanner device 2 to read an original corresponding to the image data.

With reference to FIG. 4, initially scan/transfer portion 112 sends a control signal to scanner device 2 to cause scanner device 2 to read a set original (S101) and obtains image data from scanner device 2.

The image data obtained from scanner device 2 is stored. In doing so if the image data is to be processed (YES at S103) data processing portion 114 processes the data (S105).

While in the present embodiment whether to effect the S105 step is determined at the immediately preceding step S103, it is may be determined by a setting of a program or as selected by the user in operation.

Note that when using stored image data subsequently in a variety of applications is considered, it is preferable that image data sent from scanner device 2 be exactly stored, rather than processed at step S105. However, when the size of the amount of the image data sent from scanner device 2 is considered, there is also an advantage in compressing or similarly processing the data at step S105 to allow the data to have a reduced amount for storage. Furthermore, storing image data previously processed at step S105 to also provide a correction corresponding to characteristics of scanner device 2 is also advantageous as such facilitates utilizing image data stored in an application normally used.

Then if UI portion 111 has received from a user an input of a file name of image data to be stored and/or a directory of file storage portion 12 to be a location of storage thereof (YES at S107) then in file access portion 113 the received file name is attached to the image data and the image data is stored to file storage portion 12 at a particular directory (S109).

If UI portion 11 has not received from a user an input of a file name of image data to be stored, and a directory of file storage portion 12 to be a location of storage thereof (NO at S107) then UI portion 111 inquires of the user a film name of the image data to be stored and/or a directory of file storage portion 12 to be a location of storage thereof and receives an input (S111). Alternatively, file access portion 113 may generate a file name of the image data and a directory of file storage portion 12 to be a location of storage thereof (S111). File access portion 113 then stores the image data to file storage portion 12 at a particular directory (S109) and the process thus completes.

Note that alternatively the S107 and S111 steps may be eliminated and image data may constantly be stored to file storage portion 12 with an identical file name. In this example, file storage portion 12 stores a latest, single file only.

Furthermore, at step S109, whatever the user's instruction(s) may be, file access portion 113 may automatically determine a directory based on properties of image data, such as the type, the property(s), the acquisition date, the producer and the like of the image data, for storage of the image data, and store the data to file storage portion 12. Alternatively, whatever the user's instruction(s) may be, file access portion 113 may automatically determine a directory based on the user for storage of image data, and store the image data to file storage portion 12.

Furthermore, at step S109, file access portion 113 may attach information of a date, information of a resolution, a size, a color type and any other similar parameters set for scanner device 2 that have been applied in reading image data, information specifying application 13 having transferred the image data, information specifying a user having effected the image data storage process, and other similar information to the image data in a format that can be referenced by scanner software 11, and file access portion 113 may store the same to file storage portion 12.

The FIG. 5 flow chart represents an image data transfer process obtaining and transferring image data to application 13 so that the image data can be used in application 13. The FIG. 5 process is initiated as follows: when a user starts application 13 and provides an instruction to obtain image data, CPU 101 responsively, automatically reads and executes scanner software 11 to start the process. With reference to FIG. 5, initially UI portion 111 receives a selection from a user as to whether image data is obtained from scanner device 2 or file storage portion 12 (S201). At step S201 UI portion 11 displays a screen on display 106 to the user for designating where an image that is used in application 13 is obtained and UI portion 111 receives a selection on the screen.

If image data is obtained from scanner device 2 (“scanner device” at S201) scan/transfer portion 112 causes scanner device 2 to read a set original and obtains image data from scanner device 2 (S203).

If image data is obtained from file storage portion 12 (“file storage portion” at S201) scan/transfer portion 112 causes file access portion 113 to access file storage portion 12 to obtain a particular image stored in file storage portion 12 (S205).

Furthermore, if UI portion 111 has received an instruction from the user to process the obtained image data (YES at S207), data processing portion 114 processes image data obtained at step S203 or S205 (S209). If UI portion 111 has received from the user an instruction indicating how specifically the data should be processed, then at step S209 data processing portion 111 processes the data, as specifically instructed by the user.

Scan/transfer portion 112 then transfers to application 13 the image data obtained at step S203 or S205, or the image data processed at step S209 (S211), and the process completes.

Enabling client PC 1 to execute scanner software 11 to effect the FIGS. 4 and 5 processes allows image data read from scanner device 2 to be transferred to application 13 and also to be stored as a file to file storage portion 12. Furthermore, such also allows image data read from scanner device 2 to be transferred to application 13 and also to be automatically generated regardless of the user's instruction(s) and stored to file storage portion 12 as a file. As such, once scanner device 2 has read an original image, it is no longer necessary to again operate scanner device 2 to read the same original image and image data read from the original image stored in file storage portion 12 can be used in application 13. That is, this can eliminate the necessity of reading the same original image a number of times through scanner device 2 to allow image data corresponding to a single original image variously processed to be taken in to application 13.

This allows such a usage as follows: for example, image data read from scanner device 2 is color-matched or similarly processed, and taken in to application 13, while the same image data that is not color-matched or similarly processed is also stored as a file to file storage portion 12. Then the unprocessed image data stored in file storage portion 12 is read and color-matched or similarly processed using a profile different from that used in the previous color-matching process. The image data thus processed is taken in to application 13.

Another usage is also possible, as follows: for example, image data that a user causes scanner device 2 to read is subjected to a process corresponding to exposure correction and the image data thus processed is taken in to application 13, while the same image data that is not subjected to the process corresponding to exposure correction is also stored as a file to file storage portion 12. Subsequently, if a user who does not have an original with him/her desires to change an image of the same original in exposure correction and take it in to application 13, the image data stored in file storage portion 12 and free of exposure correction is read, subjected to a process for exposure correction with a different setting, and taken in to application 13.

As such, a user who does not have an original can also enjoy such an effect as if the original is again read through scanner device 2 and a different profile is used to provide color-matching, exposure correction and other similar processing.

Still another usage is also possible, as follows: for example, image data read from scanner device 2 is color-matched or similarly processed and transferred to application 13, and also stored as a file to file storage portion 12. Such a usage can eliminate the necessity of backing up the image data processed and taken in to application 13, allowing the data to be continuously edited or similarly worked in application 13.

Note that in the image data storage process at step S109 image data read via scanner device 2 may be converted to a data format usable in application 13 and then stored to file storage portion 22. In that case, the image data transfer process's step S205 may be effected in application 13.

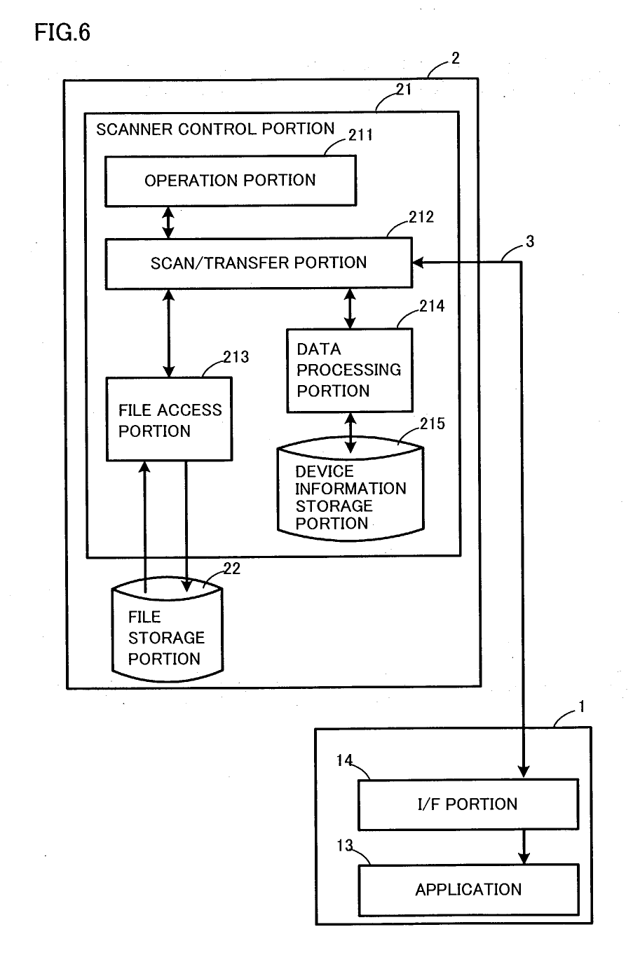

Furthermore as an exemplary variation of the present embodiment client PC 1 and scanner device 2 may functionally be configured as shown in FIG. 6. More specifically, with reference to FIG. 6, scanner device 2 includes a scanner control portion 21 configured for example of a CPU and controlling a scanner function, and a file storage portion 22 storing a file including read image data.

Scanner control portion 21 includes an operation portion 211 configured for example of an operating panel and receiving instructions from a user for operation. Operation portion 211 exhibits a function similar to that of UI portion 111 included in scanner software 11.

Furthermore in addition it includes a scan/transfer portion 212 causing the scanner function to be performed, and transmitting read image data to client PC 1, a file access portion 213 operative in response to an instruction received from scan/transfer portion 212 to access file storage portion 22, a data processing portion 214 processing image passed from scan/transfer portion 212, and a device information storage portion 215 storing information corresponding to scanner device 2. These components will not specifically be described as they are similar in function to those included in scanner software 11.

In scanner device 2 scan/transfer portion 212 transmits image data, which is received by an I/F portion 14 configured to include I/F 107 of client PC 1. I/F portion 14 passes the received image data to application 13.

Client PC 1 and scanner device 2 functionally thus configured also effect processes similar to the aforementioned image data storage and transfer processes, as has been specifically described hereinabove.

Furthermore while in the present embodiment image data storage and transfer processes have been described, data subjected to the present process are not limited to image data and may be any other data received via a data input device corresponding to scanner device 2. More specifically, motion video data, music data and the like can be included.

Furthermore the image data storage and transfer methods effected by scanner software 11 or scanner control portion 21 may be provided as programs. Such program can be recorded in a flexible disk, a compact disc (CD)-ROM, ROM, RAM, a memory card or any other similar, computer readable recording medium attached to a computer, and provided as a program product. Alternatively, the program may be recorded in a computer incorporated hard disk or any other similar recording medium for provision. Alternatively, it can be downloaded through a network.

The provided program product is installed in a program storage such as a hard disk and executed. Note that the program product includes the exact program and a recording medium having the program recorded therein.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing program product causing a computer to perform an image processing including the steps of:
receiving an input of image data from an image reader;
storing an image data based on said input image data to a memory device;
obtaining image data from one of said image reader and said memory device in response to an instruction from a user; and
transferring said obtained image data to render said obtained image data usable in an application.

2. The product of claim 1, further causing the computer to perform the step of processing said obtained image data in response to an instruction from the user, using information unique to said image reader, wherein the step of transferring renders said processed image usable in said application.

3. The product of claim 1, wherein the step of storing attaches information regarding a date of acquisition of said image data to said image data for storage to said memory device.

4. The product of claim 1, wherein the step of storing attaches information regarding an operator to said image data for storage to said memory device.

5. The product of claim 1, wherein the step of storing provides said image data with a file name received from the user for storage to said memory device.

6. The product of claim 1, wherein the step of storing provides said image data with an automatically generated file name for storage to said memory device.

7. The product of claim 1, wherein the step of storing provides said image data with a particular file name for storage to said memory device.

8. The product of claim 1, wherein the step of storing stores said image data to said memory device at a predetermined location corresponding to an attribute of said image data.

9. The product of claim 1, wherein the step of storing stores said image data to said memory device at a predetermined location associated with an operator.

10. The product of claim 2, wherein the step of processing is a color matching process unique to said image reader.

11. The product of claim 2, wherein the step of processing is an exposure correction process correcting uneven exposure.

12. The product of claim 2, wherein the step of processing is a noise removal process removing noise from said obtained image.

13. The product of claim 2, further causing the computer to perform the step of receiving an instruction indicating whether said obtained image data should be processed, wherein the step of processing processes said obtained image data in accordance with said instruction received.

14. The product of claim 2, wherein the step of storing stores either said processed image data, or said input of said image data, to said memory device.

15. The product of claim 13, wherein the step of receiving further receives an instruction indicating specific detail of said processing.

16. An image processing method comprising the steps of:
receiving an input of image data from an image reader;
storing an image data based on said input image data to a memory device;
obtaining image data from one of said image reader and said memory device in response to an instruction from a user; and
transferring said obtained image data to render said obtained image data usable in an application.

17. The method of claim 16, further comprising the step of processing said obtained image data in response to an instruction from the user, using information unique to said image reader, wherein the step of transferring renders said processed image usable in said application.

18. The method of claim 17, wherein the step of processing is an exposure correction process correcting uneven exposure.

19. The method of claim 17, further comprising the step of receiving an instruction indicating whether said obtained image data should be processed, wherein the step of processing processes said obtained image data in accordance with said instruction received.

20. An image processing apparatus comprising:
a read portion reading an original to obtain image data;
a storage portion storing said image data to a memory device;
an acquisition portion operative in response to an instruction received from a user to obtain image data from one of said read portion and said memory device; and
a transfer portion transferring said obtained image data to a different device.

21. The apparatus of claim 20, further comprising a processing portion operative in response to an instruction received from the user to process said obtained image data, using information unique to said image reader, wherein said transfer portion renders said processed image usable in said application.

22. The apparatus of claim 21, further comprising a receiving portion receiving an instruction indicating whether said obtained image data should be processed, wherein said processing portion processes said obtained image data in accordance with said instruction received.

23. The apparatus of claim 22, wherein said receiving portion further receives an instruction indicating specific detail of said processing.

24. An image processing system comprising:
a read portion using an image reader to read an original;
a storage portion storing read image data to a memory device;
an acquisition portion operative in response to an instruction received from a user to obtain image data from one of said image reader and said memory device; and
a transfer portion rendering said obtained image data usable in an application of an image processing apparatus.

25. The system of claim 24, further comprising a processing portion operative in response to an instruction received from the user to process said obtained image data, using information unique to said image reader, wherein said transfer portion renders said processed image usable in said application.

26. The system of claim 25, further comprising a receiving portion receiving an instruction indicating whether said obtained image data should be processed, wherein said processing portion operates in response to said received instruction to subject said obtained image data to said processing.

27. The system of claim 25, wherein said processing performed by said processing portion is a color matching process unique to said image reader.

28. The system of claim 25, wherein said processing performed by said processing portion is an exposure correction process correcting uneven exposure.

29. The system of claim 25, wherein said processing performed by said processing portion is a noise removal process removing noise from said obtained image.

30. The system of claim 26, wherein said receiving portion further receives an instruction indicating specific detail of said processing.
